(19) United States
(12) Patent Application Publication
(10) Pub. No.: US 2026/0163798 A1
(43) Pub. Date: Jun. 11, 2026

(54) System and method to provision data center resources

(71) Applicant: Bank of America Corporation, Charlotte, NC (US)

(72) Inventors: Aarron Gull, East Northport, NY (US); Steven W. Lester, Prosper, TX (US)

(21) Appl. No.: 18/971,918

(22) Filed: Dec. 6, 2024

(51) Int. Cl. H04L 41/16; H04L 41/0806

(52) U.S. Cl. CPC H04L 41/0823; H04L 41/0806; H04L 41/16

(57) ABSTRACT

A system comprises a memory communicatively coupled to at least one processor. The at least one processor is configured to receive first configuration feedback from a first data center and receive second configuration feedback from a second data center. Further, the at least one processor may be configured to execute the artificial intelligence algorithm to determine that the first data center uses the first resources more efficiently than the second data center uses the second resources in response to determining that the first usage efficiency of the first resources in the first data center is greater than the second usage efficiency of the second resources in the second data center, generate provisioning parameters based on the first configuration feedback, provision the third data center based on the provisioning parameters, and deploy a provisioned version of the third data center based at least in part upon the provisioning parameters.

### TECHNICAL FIELD

The present disclosure relates generally to data centers, and more specifically to a system and method to provision data center resources.

### BACKGROUND

A data center is a physical facility configured to store Information Technology (IT) operations and equipment, such as servers, storage systems, networking hardware, and other infrastructure. Several inefficiencies are associated with conventional data centers in relation to controlling, managing, and distributing resources in a data center. Additional inefficiencies exist in relation to optimizing resource consumption in a data center. In conventional data centers, large amounts of traffic in data center operations may cause data centers to slow down and/or stop operations over significant periods of time. In particular, heavy traffic loads (e.g., at, or approaching, a traffic capability) in a data center may cause the data center to drop communications deemed to be of lesser importance causing missed communications and/or incomplete data exchanges in a network.

### SUMMARY OF THE DISCLOSURE

In one or more embodiments, a system and method are configured to perform one or more provisioning operations. In particular, the system may be configured to train an artificial intelligence model to predict resource demands and/or consumption in a data center and/or a communication network. In some embodiments, the system may be configured to determine and generate provisioning parameters based on the predicted resource demands and/or consumption, provision a data center based on the provisioning parameters, and deploy provisioned versions of the data center. The data centers maybe one or more physical facilities that store application information (e.g., service configurations) and data associated with one or more operations performed in the communication network. The data center may be a location where computing and networking equipment is used to collect, process, and store data, as well as to distribute and enable access to processing resources, memory resources, and/or power resources. The system may be configured to provision data center resources. In some embodiments, the actions and/or operations of the data center may be evaluated, diagnosed, controlled, and/or managed by the system upon execution of one or more artificial intelligence algorithms in accordance with one or more artificial intelligence models. The artificial intelligence models may be supervised models and/or unsupervised models, among others. The supervised models may be models trained to understand and/or predict operations associated with a specific user profile in the communication network. The unsupervised models may be models trained to understand and/or predict operations associated with general behavior of entities interacting with the communication network. The models may be implemented in accordance with one or more guidelines, to perform network analyses using one or more neural networks, and/or one or more large language models (LLMs). The neural networks may be a computing system comprising a network of interconnected nodes, called artificial neurons, to process data in a decentralized manner. The LLMs may be artificial intelligence models that use machine learning to process and generate human language.

In one or more embodiments, the systems described herein are integrated into a practical application of dynamically generating provisioning suggestions for data centers that are planned for construction. In particular, the system may be configured to use an artificial intelligence algorithm in combination with artificial intelligence commands to analyze historical data associated with communication traffic demands and/or bandwidth usage patterns in a region, area, and/or geographical location to predict future communication demands. The future communication demands may be evaluated to determine one or more routing commands configured to guide communication operations among one or more data centers to balance a traffic load. In this regard, the practical application includes preventing communication losses in a network as the provisioned data centers and/or servers are configured to improve communication efficiency in a designated area of the data center and/or servers. Herein, efficiency may refer to an evaluation of a number of available communication resources that are used at a data center and/or server against a number of available resources in the data center and/or server. In some embodiments, the system may be configured to optimize provisioning of data centers in order to inhibit and/or prevent over routing and/or under routing of traffic. The artificial intelligence algorithm may evaluate external inputs, such as micro trends and/or macro trends in the development of load balancing technologies, to inform the predicted demand forecast and generate one or more provisioning suggestions that meet and/or match the predicted demand.

In one or more embodiments, the systems are directed to improvements in computer systems. Specifically, the systems reduce processor and memory usage in data centers and/or servers in the data centers by reducing and/or inhibiting over provisioning and/or under provisioning of data centers. Herein, processing and memory usage is reduced because processing and memory resources are not wasted in new data centers. Instead, the system provisions new data centers to include a specific number of resources that are expected to be used at higher levels of efficiency. Further, the systems are configured to prevent resources from being wasted by data centers and/or individual servers in data centers by provisioning resources in new data centers to meet and/or match specific efficiency levels. Herein, meeting and/or matching specific efficiency levels may correspond to using resources in new data centers to meet one or more specific target operational performance.

For example, performance anomalies such as CPU overutilization, memory leaks, or disk I/O bottlenecks may slow down processing and impact an entire data center. To the extent that these performance anomalies are caused by underutilization of resources and/or over utilization of resources (e.g., inefficient usage of resources), the system may be configured to predict and/or proactively address the performance anomalies before anomalies occur. In this regard, the system improves processing performance in a data center by avoiding anomalies such as CPU overutilization, memory leaks, or disk I/O bottlenecks. Another technical advantage resulting from predicting and avoiding performance anomalies includes inhibiting, reducing, and/or eliminating network congestions. Performance anomalies like network congestion or bandwidth saturation can lead to increased latency in the data center, slowing down data transfer speeds and application responsiveness. By predicting and/or proactively avoiding these anomalies from occurring, the new data centers may be configured to improve network traffic flows more smoothly, ensuring low-latency performance for applications, and services hosted in the data center.

In one or more embodiments, unlike conventional data centers, the system and method detect and/or proactively resolve performance bottlenecks promptly and effectively. Detecting performance bottlenecks occurring in a data center promptly and accurately and further promptly resolving detected performance bottlenecks provides several technical advantages. Resolving a performance bottleneck in a data center directly improves the performance of the data center in several ways. For example, resolving a performance bottleneck may result in improved data center efficiency. By addressing bottlenecks, the system may manage more requests and complete tasks more quickly. Herein, the system may be configured to increase processing data speeds, quicker application response times, and overall higher throughput. An additional technical advantage of promptly detecting and resolving performance bottlenecks may include improved resource utilization. For example, when bottlenecks are resolved, the use of data center resources like CPUs, memory, storage, and network bandwidth may be improved. These improvements may lead to more faster analyses, operations, and/or prevents certain resources from becoming overworked while resources are utilized. Another technical advantage of promptly detecting and resolving performance bottlenecks may include reduced system latency. Bottlenecks often cause delays in data transfer or processing, leading to slower response times for applications and services. By resolving bottlenecks, latency is reduced, and the performance of critical applications improves, which is especially important for time-sensitive tasks.

In one or more embodiments, the systems may comprise an apparatus, such as the server. Further, the system may be a data exchange system, which comprises the apparatus. In addition, the system may be configured to perform operations as part of a process performed by the apparatus. As a non-limiting example, the system may comprise a memory and at least one processor communicatively coupled to one another. The memory may be operable to store an artificial intelligence algorithm configured to evaluate data in accordance with one or more artificial intelligence models. The at least one processor may be configured to receive first configuration feedback from a first data center and receive second configuration feedback from a second data center. The first configuration feedback may comprise a first usage efficiency of first resources in the first data center. The second configuration feedback may comprise a second usage efficiency of second resources in the second data center. Further, the at least one processor may be configured to execute the artificial intelligence algorithm to determine whether the first usage efficiency of the first resources in the first data center is greater than the second usage efficiency of the second resources in the second data center, determine that the first data center uses the first resources more efficiently than the second data center uses the second resources in response to determining that the first usage efficiency of the first resources in the first data center is greater than the second usage efficiency of the second resources in the second data center, generate a provisioning parameters based at least in part upon the first configuration feedback, provision the third data center based at least in part upon the provisioning parameters, and deploy a provisioned version of the third data center based at least in part upon the provisioning parameters. The provisioning parameters may comprise guidance to use third resources in a third data center.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a system in accordance with one or more embodiments;

FIG. 2 illustrates an operational flow configured to evaluate, modify, and/or control communication operations in accordance with one or more embodiments;

FIG. 3 illustrates an example flowchart of a method to provision data center resources following the operational flow of FIG. 2 in accordance with one or more embodiments;

FIG. 4 illustrates an example flowchart of a method to deploy servers in data centers following the operational flow of FIG. 2 in accordance with one or more embodiments; and

FIG. 5 illustrates an example flowchart of a method to orchestrate data center resources following the operational flow of FIG. 2 in accordance with one or more embodiments.

### DETAILED DESCRIPTION

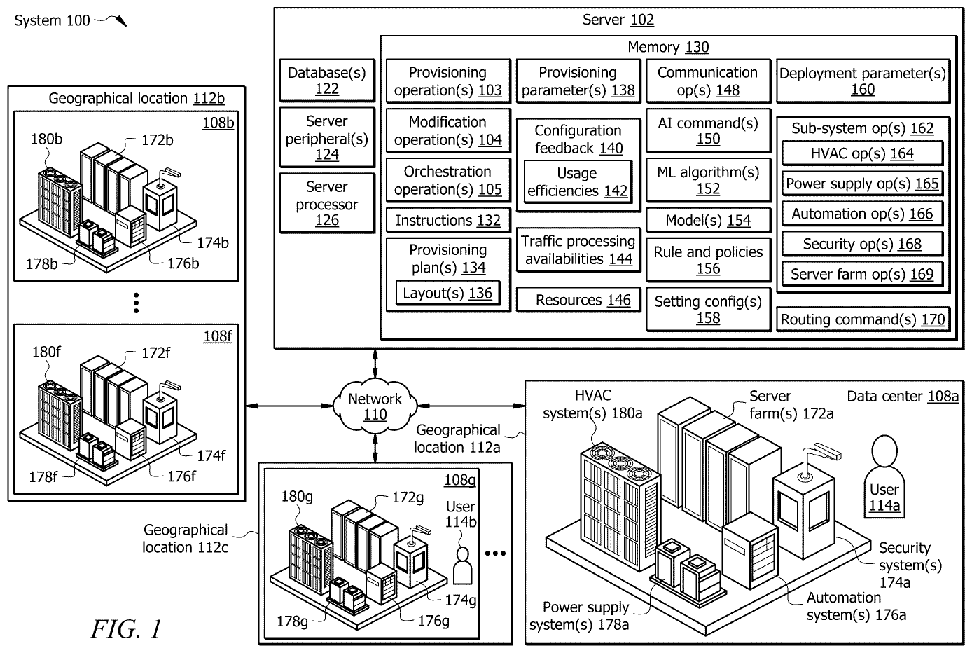

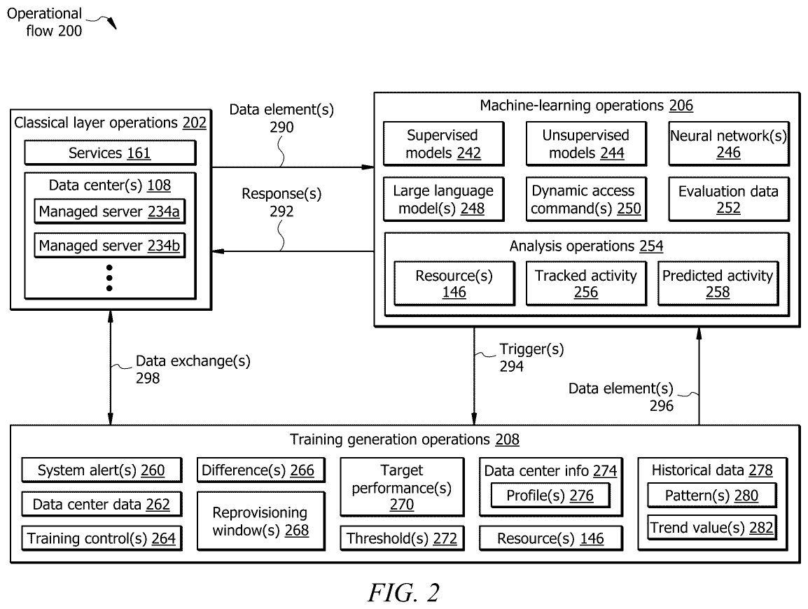

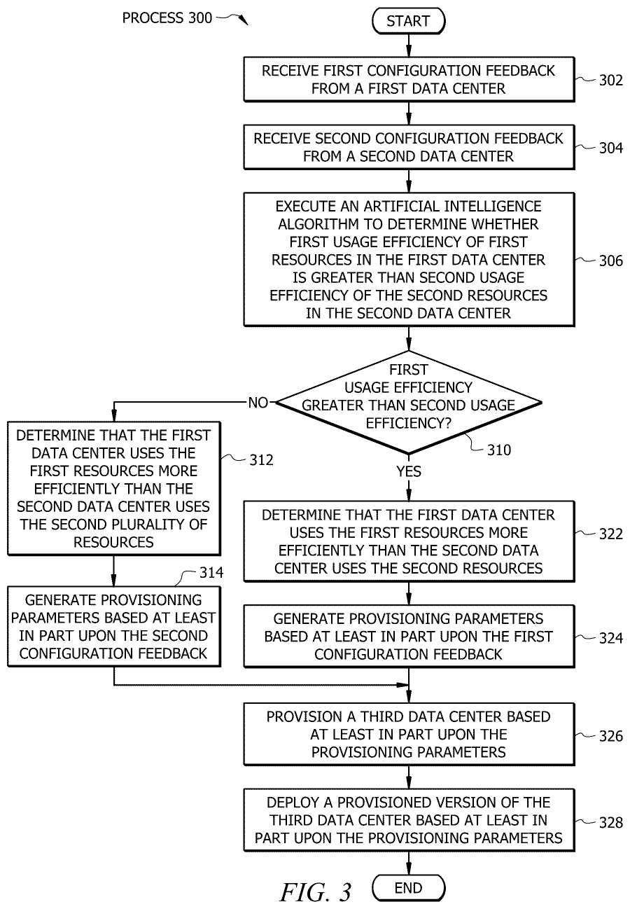

As described above, this disclosure provides various systems and methods to evaluate data center operations. FIG. 1 illustrates a system 100 in which a server 102 is configured to provision and/or deploy data centers 108 and/or servers in data centers 108 in a communication network. FIG. 2 illustrates an operational flow 200 performed by the system 100 of FIG. 1. FIGS. 3-5 illustrate a process 300, a process 400, and a process 500 respectively performed by the system 100 of FIG. 1.

### System Overview

FIG. 1 illustrates an example system 100, in accordance with one or more embodiments. The system 100 may comprise a server 102 configured to perform one or more provisioning operations 103, one or more modification operations 104, and/or one or more orchestration operations 105. The system 100 includes a server 102 communicatively coupled to a data center 108a, a data center 108b, a data center 108f, and a data center 108g (collectively, data centers 108) via a network 110. The data centers 108 may be user nodes configured to trigger exchanges of data and/or perform one or more data center operations with each other and/or with the server 102 via the network 110. The data centers 108 may be working nodes configured to receive instructions to perform one or more data center operations based on instructions received from the server 102. The data centers 108 may be one or more physical facilities that store application information (e.g., service configurations) and data associated with one or more operations performed in a communication network. The data center 108 may be a location where computing and networking equipment is used to collect, process, and store data, as well as to distribute and enable access to processing resources, memory resources, and/or power resources. In some embodiments, some of the data centers 108 may be clustered together in one or more geographical locations 112 (e.g., shown as a geographical location 112a, a geographical location 112b, and a geographical location 112c). Each of the data centers 108 may be associated with one or more corresponding operators. These operators are shown as a user 114a and a user 114b (collectively, users 114) in the geographical locations 112. In FIG. 1, the geographical location 112a is shown comprising the user 114a associated with the data center 108a. The geographical location 112c is shown comprising the user 114b associated with the data center 108g.

In one or more embodiments, the server 102 may comprise one or more databases 122, one or more server peripherals 124, one or more server processors 126, and at least one memory 130 communicatively coupled to one another. In some embodiments, the memory 130 may comprise instructions 132, one or more provisioning plans 134 comprising one or more layouts 136, one or more provisioning operations 103, one or more modification operations 104, one or more orchestration operations 105, one or more provisioning parameters 138, configuration feedback 140 comprising one or more usage efficiencies 142, one or more traffic processing availabilities 144 referencing usage of one or more resources 146 in the one or more data centers 108, one or more communication operations 148, one or more artificial intelligence (AI) commands 150, one or more machine learning (ML) algorithms 152 configured to train and/or perform one or more operations in accordance with one or more models 154, one or more rules and policies 156, one or more setting configurations 158 associated with management and/or control of one or more resources 146 in one or more of the data centers 108, one or more deployment parameters 160, one or more sub-system operations 162 comprising heating, ventilation, and air conditioning (HVAC) operations 164, one or more power supply operations 165, one or more automation operations 166, one or more security operations 168, and one or more server farm operations 169, and one or more routing commands 170.

Referring to the data center 108a a non-limiting example, the data center 108a may comprise one or more sub-systems comprising one or more server farms 172a, one or more security systems 174a, one or more automation systems 176a, one or more power supply systems 178a, one or more HVAC systems 180a communicatively coupled to one another.

### System Components

### Server

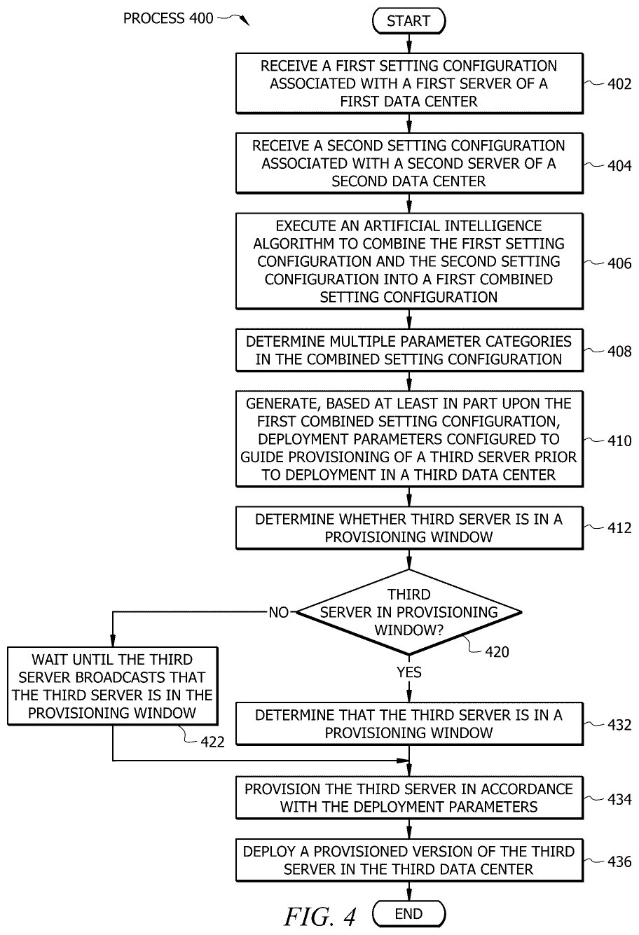

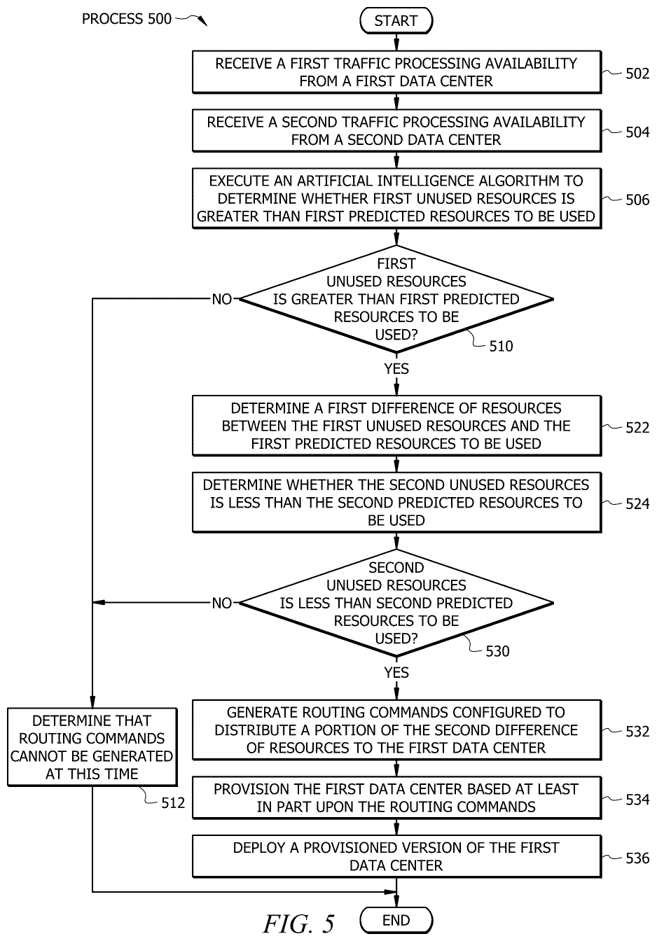

The server 102 is generally any device or apparatus that is configured to process data and communicate with computing devices (e.g., the data centers 108), additional databases, systems, and the like, via the one or more server peripherals 124 (i.e., a user interface or a network interface). The server 102 may comprise the server processor 126 that is generally configured to oversee operations of the processing engine. The operations of the processing engine are described further below in conjunction with the system 100 described in FIG. 1, the operational flow 200 described in FIG. 2, the process 300 described in FIG. 3, the process 400 described in FIG. 4, and the process 500 described in FIG. 5.

The server 102 comprises multiple databases 122 configured to provide one or more memory resources to the server 102 and the data centers 108. The server 102 comprises the server processor 126 communicatively coupled with the databases 122, the server peripherals 124, and the memory 130. The server 102 may be configured as shown, or in any other configuration. In one or more embodiments, the databases 122 are configured to store data that enables the server 102 to configure, manage and coordinate one or more middleware systems. In some embodiments, the databases 122 store data used by the server 102 to function as a halfway point in between services 161 and other tools or databases.

In one or more embodiments, the server peripherals 124 may be configured to enable wired and/or wireless communications. The server peripherals 124 may be configured to communicate data between the server 102 and data centers 108 (i.e., user devices, routers, and/or managed servers in the network 110), systems, or domain(s) via the network 110. For example, the server peripherals 124 may comprise a WI-FI interface, a LAN interface, a WAN interface, a modem, a switch, or a router. The server processor 126 may be configured to send and receive data using the server peripherals 124. The server peripherals 124 may be configured to use any suitable type of communication protocol. In some embodiments, the server peripherals 124 may be an admin console comprising a display configured to show a user interface used to manage a middleware server domain via the server 102. A middleware server domain may be a logically related group of middleware server resources that managed as a unit. A middleware server domain may comprise the server 102 and one or more managed servers. The managed servers (described in FIG. 2) may be standalone devices and/or collected devices in a server cluster. The server cluster may be a group of managed servers that work together to provide scalability and higher availability for the services 161. In this regard, the services 161 are developed and deployed as part of at least one domain. The services 161 may be applications accessed via one or more dedicated application programming interfaces (APIs). In other embodiments, one instance of the managed servers in the middleware server domain may be configured as the server 102. The server 102 provides a central point for managing and configure the managed servers, any of the one or more services 161, and the one or more local applications 194.

The at least one server processor 126 may comprise one or more processors communicatively coupled to the memory 130. The server processor 126 may be any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 126 may be a programmable logic device, a microcontroller, a microprocessor, or any suitable combination of the preceding. The one or more server processors 126 may be configured to process data and may be implemented in hardware or software executed by hardware. For example, the server processor 126 may be 8-bit, 16-bit, 32-bit, 64-bit or of any other suitable architecture. The server processor 126 may include an arithmetic logic unit (ALU) for performing arithmetic and logic operations, processor registers that supply operands to the ALU and store the results of ALU operations, and a control unit that fetches the instructions 132 from the memory 130 and executes them by directing the coordinated operations of the ALU, registers and other components. In this regard, the one or more server processors 126 are configured to execute various instructions. For example, the one or more server processors 126 are configured to execute the instructions 132 to implement the functions disclosed herein, such as some or all of those described with respect to FIGS. 1-5. In some embodiments, the functions described herein are implemented using logic units, FPGAs, ASICs, DSPs, or any other suitable hardware or electronic circuitry.

In one or more embodiments, the server peripherals 124 may be any suitable hardware and/or software to facilitate any suitable type of wireless and/or wired connection. These connections may include, but not be limited to, all or a portion of network connections coupled to the Internet, an Intranet, a private network, a public network, a peer-to-peer network, the public switched telephone network, a cellular network, a local area network (LAN), a metropolitan area network (MAN), a wide area network (WAN), and a satellite network. The server peripherals 124 may be configured to support any suitable type of communication protocol as would be appreciated by one of ordinary skill in the art.

The memory 130 may be volatile or non-volatile and may comprise a read-only memory (ROM), random-access memory (RAM), ternary content-addressable memory (TCAM), dynamic random-access memory (DRAM), and static random-access memory (SRAM). The memory 130 may be implemented using one or more disks, tape drives, solid-state drives, and/or the like. The memory 130 is operable to store the instructions 132, the one or more provisioning plans 134 comprising the one or more layouts 136, the one or more provisioning operations 103, the one or more modification operations 104, the one or more orchestration operations 105, the one or more provisioning parameters 138, the configuration feedback 140 comprising the one or more usage efficiencies 142, the one or more traffic processing availabilities 144 referencing usage of the one or more resources 146 in the one or more data centers 108, the one or more communication operations 148, the one or more AI commands 150, the one or more ML algorithms 152 configured to train and/or perform one or more operations in accordance with the one or more models 154, the one or more rules and policies 156, the one or more setting configurations 158 associated with management and/or control of the one or more resources 146 in one or more of the data centers 108, the one or more deployment parameters 160, the one or more sub-system operations 162 comprising HVAC operations 164, the one or more power supply operations 165, the one or more automation operations 166, the one or more security operations 168, and the one or more server farm operations 169, and the one or more routing commands 170, and/or any other data or instructions. The instructions 132 may comprise any suitable set of instructions, logic, rules, or code operable to execute the server processor 126.

The provisioning plans 134 may comprise one or more development stages to be used over one or more periods of time. The provisioning plans 134 may be one or more building stages in which different systems of the data centers 108 are assembled, installed, and/or build in a geographical location. The provisioning plans 134 may comprise bill of materials, assembling instructions, and/or setting configurations 158 to complete construction of a new data center 108. The provisioning plans 134 may be one or more processes for completing one or more data centers 108. Each provisioning plan 134 may comprise at least one plan duration, one or more sub-operations, and one or more operation points. The one or more plan durations may be a time-based duration and/or an operation-based duration in which a given construction operation and/or communication operations are expected to be completed. The one or more sub-operations may be one or more operations performed in accordance with one or more communication levels and/or one or more evaluation levels. The one or more operation points may be one or more construction milestones and/or stops in which portions of the new data center are modified to complete a given construction operation. The provisioning plans 134 may comprise one or more layouts 136 configured to provide guidelines and/or guidance on assembly and/or configuration settings for one or more data center equipment.

In some embodiments, the provisioning operations 103, the modification operations 104, the one or more orchestration operations 105, and/or the one or more communication operations 148 may be executed by the server processor 126 configured to enable data objects comprising one or more data elements to be exchanged between the server 102, the data centers 108, and/or one or more additional devices communicatively coupled to the server 102 based on the one or more rules and policies 156. In one or more embodiments, the provisioning operations 103, the modification operations 104, the one or more orchestration operations 105, and/or the one or more communication operations 148 may be configured to indicate one or more data objects (e.g., via data object information) to be exchanged between the server 102 and at least one of the data centers 108. The data exchange operations 104 may be configured to generate and analyze one or more requests and/or one or more reports. The reports may comprise data indicating warnings and alerts among other information. In some embodiments, the reports may be audio and/or visual signaling presented in the one or more server peripherals 124. The one or more requests may be one or more communications configured to provide triggers in the form of communication or control signals to start operations such as fetching the instructions 132 or running one or more of data exchange operations. The requests may provide user information to the server 102 to indicate at least one data center profile associated with one or more of entitlements to access and/or modify any of the services 161 available in the server 102. The requests may be configured to provide lists, security information, and configuration commands that the server 102 uses to set up a specific service 161 for one of the data centers 108. The requests may comprise data that provides starting procedure configuration to the server 102. In one or more embodiments, the requests may be optimized (e.g., simplified to a target state of efficiency) instructions that trigger establishing of a specific procedure in the server 102.

In one or more embodiments, the requests may be one or more information strings, alphanumeric data, and/or configuration commands to be exchanged in a data network. The one or more requests may be configured to trigger one or more of the data exchange operations 104 and/or one of the communication operations. The requests may be exchanged in bulk or individually over the network 110. The requests may be one or more communications configured to provide triggers in the form of communication or control signals to start operations such as fetching the instructions 132 or performing the provisioning operations 103, the modification operations 104, the one or more orchestration operations 105, and/or the one or more communication operations 148. The requests may provide user information to the server 102 to indicate at least one data center profile associated with one or more of the entitlements to access and/or modify any of the services 161 available in the server 102.

The requests may be one or more communications configured to provide triggers in the form of communication or control signals to start operations such as fetching the instructions 132 or running one or more of the provisioning operations 103, the modification operations 104, the one or more orchestration operations 105, and/or the one or more communication operations 148.

In one or more embodiments, the provisioning operations 103, the modification operations 104, the one or more orchestration operations 105, and/or the one or more communication operations 148 may be one or more operations performed by one or more services 161. The provisioning operations 103, the modification operations 104, the one or more orchestration operations 105, and/or the one or more communication operations 148 may be one or more operations comprising multiple stages and/or transitions at different services 161. For example, one or more of the provisioning operations 103, the modification operations 104, the one or more orchestration operations 105, and/or the one or more communication operations 148 may be configured to start at one service 161 that transitions to other data centers 108. For example, the server 102 may be configured to set up one or more of the provisioning operations 103, the modification operations 104, the one or more orchestration operations 105, and/or the one or more communication operations 148 and one or more data elements and/or data records to be modified by the one or more services 161.

The provisioning operations 103 may be one or more one or more commands and/or guidelines configured to inform allocation of resources 146 in a data center 108 and/or one or more servers associated with specific data centers 108. The provisioning operations 103 may comprise one or more instructions to purchase, order, construct, and/or assemble equipment in a data center 108 and/or a specific portion of the data center 108. For example, the provisioning operations 103 may comprise instructions to purchase, install, and configure one or more HVAC solution in a given data centers 108.

The modification operations 104 may be one or more one or more commands and/or guidelines configured to inform modification of resources 146 in a data center 108 and/or one or more servers associated with specific data centers 108. The modification operations 104 may comprise one or more instructions to move, rearrange, and/or exchange equipment in a data center 108 and/or a specific portion of the data center 108. For example, the modification operations 104 may comprise instructions to replace, reinstall, and/or reconfigure one or more HVAC systems 180 in a given data center 108.

The one or more orchestration operations 105 may be one or more one or more commands and/or guidelines configured to inform movement and/or changes of of resources 146 in a data center 108 and/or one or more servers associated with specific data centers 108. The orchestration operations 105 may comprise one or more instructions to move, rearrange, and/or exchange equipment in a data center 108 and/or a specific portion of the data center 108. For example, the orchestration operations 105 may comprise instructions to reroute, reallocate, and/or reposition one or more configuration settings in one or more HVAC systems 180 of a given data center 108.

The one or more communication operations 148 may be one or more data exchanges performed between two or more network devices in the system 100. The network devices may comprise the server 102 and one or more of the data centers 108, among others. In one or more embodiments, the communication operations 148 may be audio communications exchanged as part of audio conversations (e.g., during a telephonic call) between two or more network devices. The communication operations 148 may be image and/or text communications exchanged as part of image-based conversations (e.g., during videocalls and/or chat exchanges) between two or more network devices.

The one or more provisioning parameters 138 and the one or more deployment parameters 160 may be one or more indicators configured to provide information associated with one or more operations of the entities accessing the network 110. The one or more provisioning parameters 138 and the one or more deployment parameters 160 may be stored in one or more formats. The one or more provisioning parameters 138 and the one or more deployment parameters 160 may be configured to generate one or more access commands based on configuration feedback 140 and/or setting configurations 158. In this regard, the access commands may be information indicating modifications and/or assignments of resources 146 in the network 110. The access commands may be replaced, updated, and/or modified dynamically. The access commands may comprise results of one or more operations of the processing engine configured to perform one or more of the provisioning operations 103, the modification operations 104, the orchestration operations 105, the communication operations 148, and/or the sub-system operations 162. The access commands may be one or more triggers configured to enable access between the data centers 108 determined to perform one or more legitimate communication operations 148.

The one or more provisioning parameters 138 may be configured to instruct and/or trigger provisioning aspects of one or more servers and/or one or more data centers 108. The provisioning aspects may comprise one or more provisioning plans 134, layouts 136, and/or equipment arrangements for one or more servers and/or data centers in one or more geographical locations 112. The one or more deployment parameters 160 may be configured to instruct and/or trigger deployment aspects of one or more servers and/or one or more data centers 108. The deployment aspects may comprise dates, times, and/or configurations for one or more servers and/or data centers in one or more geographical locations 112.

The configuration feedback 140 may comprise data, metadata, and one or more reports. The configuration feedback 140 may comprise information provided by and/or obtained from the data centers 108 during one or more communication operations 148. The server 102 may be configured to perform one or more retrieving operations configured to determine data and/or metadata from the communication operations 148 and generate one or more reports associated with interactions of the data centers 108 in the network 110. The configuration feedback 140 may be provided continuously and/or periodically over time from one or more of the data centers 108 to the server 102. The configuration feedback 140 may be data indicating whether any of the data centers 108 are attempting to perform one or more specific data exchange operations in the network 110. The configuration feedback 140 may be obtained via one or more of the server peripherals 124. The configuration feedback 140 may comprise multiple data samples. Each data sample may comprise a magnitude and a duration. The configuration feedback 140 may be configured to indicate one or more attempted actions associated with the communication operations 148. The configuration feedback 140 may indicate one or more changes in the behavior associated with one or more of the data centers 108. In one or more embodiments, the data may be information data representative on one or more communication operations 148 performed and/or triggered by the one or more data centers 108. The metadata may be data that represents extracted information and/or summarized information associated with one or more operations attempted and/or performed by the data centers 108. In the example of FIG. 1, the data and/or metadata may be active information comprising business metadata and/or passive information comprising technical metadata. The active information may be metadata used by one of the applications and may be dynamic in nature. The passive information may be metadata collected from the applications during one or more application operations and may be static in nature. In one or more embodiments, the reports comprise one or more communications and/or transmissions configured to provide information relating to a status of one or more of the communication operations 148. The reports may comprise and/or trigger alerts to other servers and/or one or more of the data centers 108. The configuration feedback 140 may comprise one or more usage efficiencies 142 configured to represent one or more usage efficiencies of the resources 146. The usage efficiencies 142 may be configured to reference and/or indicate performance of one or more aspects of performance in the data centers 108.

In one or more embodiments, the traffic processing availabilities 144 may be configured to reference one or more processing capabilities of one or more of the servers and/or data centers 108. The traffic processing availabilities 144 may reference whether one or more servers and/or one or more data centers 108 are capable of handling one or more additional operations over a period of time. In some embodiments, the traffic processing availabilities 144 may represent one or more unused resources 146 in a server and/or a data center 108 within a period of time.

The resources 146 may be one or more memory resources, processor resources, and/or power resources in a given server and/or a given data center. The resources 146 may comprise one or more memory units and/or processing units allocated to complete one or more operations in the data centers 108. The resources 146 may be one or more aspects of data centers 108 configured to perform one or more specific operations in a server and/or one or more of the sub-system operations 162 of the data center 108.

In one or more embodiments, the ML algorithms 152 may be executed by the server processor 126 to evaluate the provisioning operations 103, the modification operations 104, the one or more orchestration operations 105, and/or the one or more communication operations 148. Further, the ML algorithms 152 may be one or more artificial intelligence algorithms configured to interpret and transform the requests and/or the instructions 132 into structured data sets and subsequently stored as files or tables. The ML algorithms 152 may cleanse, normalize raw data, and derive intermediate data to generate uniform data in terms of encoding, format, and data types. The ML algorithms 152 may be executed to run user queries and advanced analytical tools on the structured data and/or the unstructured data in accordance with one or more models 154. The ML algorithms 152 may be configured to generate the one or more AI commands 150 based on one or more results of the provisioning operations 103, the modification operations 104, the one or more orchestration operations 105, and/or the one or more communication operations 148. The AI commands 150 may be parameters that proactively trigger one or more of the data exchange operations 104. The AI commands 150 may be combined with the existing instructions 132 to dynamically trigger and/or perform one or more data authentication operations and/or some or all of the data exchange operations 104. The AI commands 150 may be configured to trigger one or more cognitive AI operations in accordance with one or more models 154. The models 154 may be trained by the one or more ML algorithms 152 based on historic information associated with any data exchange operations 104 performed by the services 161 and/or the server 102.

The models 154 may be computational framework designed to perform tasks that typically require human intelligence, such as pattern recognition, decision-making, language processing, and problem-solving. The models 154 may be artificial intelligence models built using algorithms (e.g., machine-learning algorithms 152) that learn from data (e.g., training data) to make predictions, classifications, or generate outputs (e.g., result data). The models 154 may be based on machine learning (ML) and deep learning techniques. Each model 154 may use at least one machine-learning algorithm 152 that includes a set of rules or mathematical functions that guide the model 154 to learn from data. In some embodiments, common types of machine-learning algorithms 152 include, but are not limited to, supervised learning algorithms, unsupervised learning algorithms, and reinforcement learning algorithms. In supervised learning, the model 154 is trained based on labeled data (e.g., input-output pairs) to learn a mapping. In unsupervised learning, the model 154 identifies patterns and structures in unlabeled data. In reinforcement learning, the model 154 learns by interacting with an environment and by receiving feedback to fine tune the algorithm.

The rules and policies 156 may be security configuration commands or regulatory operations predefined by an organization or one or more users 114. In one or more embodiments, the rules and policies 156 may be dynamically defined by the one or more users 114. The rules and policies 156 may be prioritization rules configured to instruct one or more user devices 106 to perform one or more evaluating operations or perform one or more operations in the system 100 in a specific communication operation 148. The one or more rules and policies 156 may be predetermined or dynamically assigned by a corresponding user 114 or an organization associated with the users 114.

The setting configurations 158 may be one or more configuration selections for one or more servers and/or one or more data centers 108. The setting configurations 158 may instruct operation arrangements of one or more of the services 161 and/or one or more configuration aspects of the server and/or the data centers 108 over a period of time. The setting configurations 158 may reference one or more configuration aspects of specific sub-systems in the data centers 108.

The sub-system operations 162 may be one or more operations performed by one or more of the servers and/or one or more of the data centers 108. The sub-system operations 162 may be one or more operations that relate to one or more sub-systems in a specific data center 108. The sub-system operations 162 may comprise one or more HVAC operations 164, one or more power supply operations 165, one or more automation operations 166, one or more security operations 168, and/or one or more server farm operations 169. The HVAC operations 164 may comprise one or more operations associated with ventilation control, regulation and/or analysis of the HVAC systems 180 in a given data center 108. The power supply operations 165 may comprise one or more operations associated with power generation, distribution, and/or storage of the power supply systems 178 in a given data center 108. The automation operations 166 may comprise one or more operations associated with automation, data analyses, and/or training mechanisms in a given data center 108. The security operations 168 may comprise one or more operations associated with safety, encryption/decryption, and/or control of sensitive information exchanged with a given data center 108. The server farm operations 169 may comprise one or more operations associated with server operations, decentralized data analyses performed in decentralized networks, and/or centralized communications associated with one or more servers in a given data center 108.

The routing commands 170 may be configured to guide routing of one or more data elements, pieces of information data, and/or configuration commands within the network 110. The routing commands 170 may be configured to start, control, organize, and/or stop one or more communication operations 148 exchanged with one or more of the data centers 108. The routing commands 170 may be configured to divide one or more bandwidth traffic from one portion of a communication spectrum to another and/or divide the communication spectrum in multiple portions.

In one or more embodiments, the databases 122 may be one or more repositories configured to store information. In one example, the server 102 may determine whether the server processor 126 is available (e.g., running) to perform a specific service. In another example, the server 102 may determine that a specific managed server is running to enable a testing application and/or perform the specific service upon receiving a server response indicating that a corresponding managed server is available to perform the service. The databases 122 may be configured to store one or more representations of data instead of storing coded data. In this regard, the representations may be encoded in accordance with an encoder configured to identify and/or verify exchanged information. For example, the databases 122 may comprise one or more representations of the configuration feedback 140. As the configuration feedback 140 is obtained, the server processor 126 may be configured to process the configuration feedback 140 in accordance with one or more operations triggered and/or caused upon execution of the ML algorithm 152.

### Network

The network 110 facilitates communication between and amongst the various devices of the system 100. The network 110 may be any suitable network operable to facilitate communication between the server 102 and the data centers 108 of the system 100. The network 110 may include any interconnecting system capable of transmitting audio, video, signals, data, data packets, messages, or any combination of the preceding. The network 110 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the devices.

### Dara Center

In one or more embodiments, the data centers 108 maybe one or more physical facilities that store application information (e.g., service configurations) and data associated with one or more operations performed in the communication network. The data centers 108 may be a location where computing and networking equipment is used to collect, process, and store data, as well as to distribute and enable access to processing resources, memory resources, and/or power resources. In some embodiments, the server 102 may be located in one or more of the data centers 108.

The data centers 108 may employ a combination of hardware sensors and service (e.g., software applications) to record one or more performance metrics associated with the data centers 108. In some embodiments, the hardware sensors include, but are not limited to, climate sensors, power sensors that measure power consumption, humidity sensors, differential pressure sensors that monitor airflow by measuring pressure differences between different areas of a data center 108 or data center sub-systems, and vibration sensors. The services may be configured to monitor and record performance metrics may include performance monitoring (PM) tools that are configured to monitor, measure and/or determine several performance metrics associated with the data center 108 such as CPU response time, CPU usage, memory usage, error rate, application response time, availability of an application, throughput, network latency, disk input (I)/output (O) and the like. For example, a performance monitoring tool may determine the CPU response time based on the measured CPU utilization percentage.

In one or more embodiments, each of the data centers 108 (e.g., the data center 108a in the geographical location 112a, the data centers 108b-108g in the geographical location 112b, and the data center 108g in the geographical location 112g) may comprise one or more computing devices configured to communicate with other devices, such as the server 102, one or more of the sub-systems, databases, and the like in the system 100. Each of the data centers 108 may be configured to perform specific functions described herein and interact with the server 102 and/or any other data centers 108. Examples of computing devices in the data centers 108 comprise, but are not limited to, a laptop, a computer, a smartphone, a tablet, a smart device, an internet-of-things (IoT) device, a simulated reality device, an augmented reality device, or any other suitable type of device. The data centers 108 may comprise one or more interfaces and/or peripherals comprising I/O displays, voice microphones, or sensors capturing gestures performed by a corresponding user 114.

The data centers 108 may comprise hardware configured to create, transmit, and/or receive information. The data centers 108 may be configured as a provider node or as worker nodes in the network 110. The data centers 108 may be configured to receive inputs from a user 114, process the inputs, and generate data information or command information in response. The data information may include informational messages, error messages, and/or documents or files generated using a graphical user interface (GUI). The informational messages and the error messages may be generated based on recorded values of one or more performance metrics and may include the recorded values of the one or more performance metrics and other information such as alerts and recommendations.

The data centers 108 may employ systems that generate and/or are used to generate performance indicators indicating performance of various hardware and/or software components associated with a given data center 108. Each performance indicator may include, but is not limited to, informational messages, error messages, recorded values of performance metrics, or a combination thereof. An informational message in a data center 108 may be a notification that provides details about a previous status and/or current status of a system and/or device within the given data center 108, indicating and/or referencing normal operations, non-critical events, and/or updates without any immediate action required. In some embodiments, an informational message is a message conveying non-urgent information about one or more conditions and/or functionality at the data center 108. An error message in a data center 108 may be a notification that alerts operators (e.g., users 114) to a problem and/or solvable event occurring within the data center infrastructure, such as a server malfunction, network connectivity loss, storage failure, and/or power supply issue, signaling that something is not functioning as expected and needs attention.

In one or more embodiments, the one or more interfaces may be any suitable hardware or software (e.g., executed by hardware) configured to facilitate any suitable type of communication in wireless or wired connections. These connections may comprise, but not be limited to, all or a portion of network connections coupled to additional data centers 108, the server 102, the Internet, an Intranet, a private network, a public network, a peer-to-peer network, the public switched telephone network, a cellular network, a LAN, a MAN, a WAN, and a satellite network. The interfaces may be configured to support any suitable type of communication protocol. In one or more embodiments, the one or more peripherals may comprise audio devices (e.g., speaker, microphones, and the like), input devices (e.g., keyboard, mouse, and the like), or any suitable electronic component that may provide a modifying or triggering input to the data centers 108. For example, the one or more peripherals may be speakers configured to release audio signals (e.g., voice signals or commands) during media playback operations. In another example, the one or more peripherals may be microphones configured to capture audio signals. In one or more embodiments, the one or more peripherals may be configured to operate continuously, at predetermined time periods or intervals, or on-demand.

The one or more processors may be communicatively coupled to and in signal communication with the one or more interfaces, the one or more peripherals, and the one or more memories. The one or more processors may be any electronic circuitry, including, but not limited to, state machines, one or more CPU chips, logic units, cores (e.g., a multi-core processor), FPGAs, ASICs, or DSPs. The one or more processors may be programmable logic devices, microcontrollers, microprocessors, or any suitable combination of the preceding. The one or more processors may be configured to process data and may be implemented in hardware or software executed by hardware. For example, the one or more processors may be 8-bit, 16-bit, 32-bit, 64-bit, or any other suitable architecture. The one or more processors may comprise an ALU to perform arithmetic and logic operations, processor registers that supply operands to the ALU, and store the results of ALU operations, and a control unit that fetches software instructions such as data center instructions from the memory and executes the instructions by directing the coordinated operations of the ALU, registers, and other components via a processing engine. The one or more processors may be configured to execute various instructions.

The memory may comprise multiple operation data and one or more local applications (e.g., server) associated with the server 102. The operation data may be data configured to enable one or more data processing operations such as those described in relation with the server 102. The operation data may be partially or completely different from those comprised in the memory 130. The local applications may be one or more of the services described in relation with the server 102. In some embodiments, the local applications may be partially or completely different from those comprised in the memory 130.

Referring as a non-limiting example to the data center 108a of FIG. 1, the data center 108a may be hardware and/or software, executed by hardware, that manages, controls, and/or monitors the resources 146 and/or data stored in the data center 108a. Although not explicitly shown in FIG. 1, the data center 108a may include one or more processors, one or more memories, and one or more transceivers configured to generate one or more communication signals. In one or more embodiments, the data center 108a is a device, a system, and/or a combination of systems and/or devices in a predetermined geographical location 112a in which the server 102 and/or the user devices 106 are located. In some embodiments, radio waves, electromagnetic (EM) signaling, and/or communication operations 148 from the data center 108a are monitored over time in the network 110 to be evaluated in combination with the one or more provisioning operations 103, the one or more modification operations 104, and/or the one or more orchestration operations 105, among others.

In one or more embodiments, a performance metric associated with a given data center 108 may comprise measurable units that indicate performance of a data center equipment (or component therein) or a software application. The performance metrics may be monitored and measured in a data center 108 including, but not limited to, ventilation levels associated with a data center equipment (e.g., server farms 172) or a component therein (e.g., CPU), power consumption of a data center equipment, humidity, airflow, vibrations, CPU response time, CPU usage, memory usage, error rate, application response time, availability of an application, throughput, network latency, and disk I/O. CPU response time is a measure of the time taken by a CPU to respond to a request. CPU usage is a percentage of processing power utilized by software applications running at one or more server farms 172 that may highlight potential performance bottlenecks. The memory usage is an amount of memory (e.g., random access memory (RAM)) consumed at the one or more server farms 172. The error rate may be a percentage of requests that result in error, signifying application stability and potential anomalies. The application response time may indicate a time taken by a software application to respond to a request indicating how quickly the application reacts to interactions. The availability of an application may be a percentage of time a software application is operational and accessible to users and systems. The throughput may be a number of requests that the server farms 172 or a software application can process per unit time (e.g., per second) indicating its capacity to manage traffic. The network latency may be a time that takes for data to travel between one or more elements in the data center equipment and/or data center sub-systems. The disk I/O may be a rate at which data is read and written to a storage device.

The one or more server farms 172 may be one or more server clusters and/or a collection of computer servers maintained and/or provisioned dynamically and/or periodically over time. The server farms 172 may comprise large numbers of servers comprising several (e.g., hundreds, thousands, and/or hundreds of thousands) computing systems and/or devices. The server farms 172 may comprise one or more servers configured to perform one or more specific operations in accordance with one or more specific services 161. The server farms 172 may be comprise one or more backup units configured to provide redundancies and/or support to one or more operations and/or services 161 in a given data center 108. The server farms 172 may comprise one or more core processing units that run various services 161 and sometimes store data. The server farms 172 may be deployed at a data center 108 to comprise several types of storage devices and systems such as traditional hard drives (HDDs), solid-state drives (SSDs), and specialized systems like Storage Area Networks (SANs) or Network-Attached Storage (NAS). The server farms 172 may comprise servers configured with and/or comprising networking equipment comprising switches and routers that facilitate internal communication between data center equipment (e.g., between servers) as well as external communication between the data center 108 and devices/systems external to the data center 108 (e.g., other data centers 108). As shown in the example of FIG. 1, a data center 108 may comprise at least one server farm 172 comprising multiple server racks that house several types of data center equipment. For example, a server rack may include servers, networking equipment (e.g., switches and/or routers), storage solutions, power distribution units (PDUs) that distribute electrical power to equipment within a server rack, cables that connect different devices within the rack and other part of the data center 108, patch panels used to organize and manage network cables, cable management system that assist in keeping cables organized and prevent clutter, or combinations thereof.

In one or more embodiments, services 161 and/or software applications that are hosted and/or run in the data center 108 (e.g., by servers in the server farms 172) may include, but are not limited to, operating systems, virtualization software, management and orchestration software, security systems 174, performance monitoring tools, backup and recovery software, database management systems (DBMS), or a combination thereof.

The one or more security systems 174 may be configured to protect one or more components of a data center 108 from unauthorized access, theft, and/or corruption. The one or more security systems 174 may comprise network security configured to use firewalls, intrusion detection systems, and other security measures to protect the network 110 that connects the data center 108. The one or more security systems 174 may comprise intrusion detections configured to use intrusion detection systems (IDS) to identify unauthorized access to the data center 108 and alert security personnel. The one or more security systems 174 may comprise one or more firewalls configured to use security systems to monitor and control incoming and outgoing network traffic. The one or more security systems 174 may be comprise data encryption configured to use data encryption to ensure information that is unreadable to unauthorized users. The one or more security systems 174 may comprise access controls configured to enable services 161 in one or more servers, allow access based on authorization commands, and use strong safety controls. The one or more security systems 174 may comprise data center security encompassing practices and preparation configured to keep a given data center 108 secure from threats, attacks, and unauthorized access.

The one or more automation systems 176 may be hardware and/or software executed by hardware configured to manage and/or execute routine data center operations like provisioning servers, monitoring performance, managing storage, network configuration, and disaster recovery without manual intervention, optimizing efficiency and reducing human error. The one or more automation systems 176 may comprise one or more routine workflows and processes of a data center 108 comprising scheduling, monitoring, maintenance, application delivery, and the like.

The one or more power supply systems 178 may be configured to receive, process, and/or distribute power in the data center 108. The one or more power supply systems 178 may comprise one or more uninterruptible power supplies (UPSs), one or more power distribution units (PDUs), and one or more remote power panels (RPPs). The UPSs may comprise battery backups to cover a time between a detection of utility issues and a generator starting. The PDUs may comprise individual equipment racks that are served by PDUs offering both metered and unmetered options. With metered PDUs, the data center 108 may obtain more analytics associated with power consumption. The RPPs may comprise connectors between the PDUs and the individual devices. The one or more power supply systems 178 may be configured to retrieve data from a power generator, an electrical grid, and/or an alternative power source prior to distribution in the data center 108. The one or more power supply systems 178 may be configured to provide electrical power to various data center equipment and components thereof in a data center 108 such as servers, networking equipment, storage solutions, and HVAC solutions.

The one or more HVAC systems 180 may be configured to regulate and/or control humidity and/or airflow within the data center 108, ensuring proper functioning of sensitive computer servers by maintaining a consistent cool environment and filtering out dust particles that could damage equipment. The one or more HVAC systems 180 may comprise one or more solutions configured to prevent overheating of servers and other hardware within the data center 108. The one or more HVAC systems 180 may comprise chillers and cooling towers configured to cool water that circulates through the data center 108, absorb heat from the air, and/or dissipate heat into the atmosphere, ensuring the water remains at an optimal warmth and/or cool level. The one or more HVAC systems 180 may comprise one or more air distribution systems configured to ensure that cooled air is evenly distributed throughout the data center 108, maintaining uniform conditions across all server racks. The one or more HVAC systems 180 may be configured to maintain optimal climate conditions for the data center equipment and may include air conditioning systems, liquid cooling systems, and/or other systems employing advanced cooling technologies to avoid and/or prevent overheating of data center equipment (e.g., servers).

Operational Flow to Provision and Deploy Data Centers and/or Individual Servers in the Data Centers

FIG. 2 shows an operational flow 200 in which the system 100 of FIG. 1 is configured to provision, reprovision, deploy, and/or redeploy data centers 108 and/or individual servers in the data centers 108, in accordance with one or more embodiments. In FIG. 2, the operational flow 200 comprises multiple operations 202-208. The operational flow 200 may be performed between the server 102 and one or more entities (e.g., user devices, network components, and/or the data centers 108 among others). The operational flow 200 shows classical layer operations 202 comprising one or more services 161 and one or more managed servers 234 (e.g., a managed server 234a and a managed server 234b among other), one or more machine learning operations 206 comprising one or more supervised models 242, one or more unsupervised models 244, one or more neural networks 246, one or more large language models (LLMs) 248, one or dynamic access commands 250, and/or evaluation data 252, and one or more analysis operations 254 comprising information relating to one or more resources 146, tracked activity 256, and predicted activity 258. The operational flow 200 shows training generation operations 208 comprising one or more system alerts 260, one or more data center data 262, one or more training controls 264, one or more differences 266, information relating to reprovisioning windows 268, one or more target performances 270, data center information 274 comprising one or more data center profiles 276, information relating to one or more of the resources 146, and historical data 278 comprising one or more patterns 280 and/or one or more trend values 282. In the example of FIG. 2, the classical layer operations 202 may generate one or more data elements 290 to perform the one or more machine learning operations 206 and receive one or more responses 292 from the machine learning operations 206. In turn, the machine learning operations 206 may generate one or more triggers 294 to perform the one or more training generation operations 208 and receive one or more data elements 296 from the training generation operations 208. In some embodiments, the training generation operations 208 and the classical layer operations 202 may be performed after causing one or more data exchanges 298. The training generation operations 208 may be one or more artificial training operations configured to analyze, modify, and/or generate one or more elements of training data.

The classical layer operations 202 may comprise one or more operations performed by the server processor 126. In the classical layer operations 202, the server 102 may be configured to invoke the AI commands 150 and/or the ML algorithms 152 to evaluate one or more communication operations 148 from an entity attempting to access network resources in the system 100. The server 102 may be configured to provide one or more data elements 290 as outputs to the machine learning operations 206. The classical layer operations 202 may be one or more operations configured to provide access between one or more data centers 108 and one or more services 161 (e.g., applications). The services 161 may be configured to provide access to one or more network resources in the network 110 via the server 102 and/or one or more managed servers 234 located in one or more data centers 108. The one or more managed servers 234 (e.g., shown as the managed server 234a and the managed server 234b among others) may be one or more of the servers in the server farms 172. The one or more data elements 290 may be individual data in one or more data objects. The data elements 290 may be alphanumeric bitstrings comprising a specific format. The data elements 290 may be data information configured to reference data objects stored in a specific database. The data elements 290 may be comprise one or more of the configuration feedback 140, one or more setting configurations 158, and/or one or more traffic processing availabilities 144 associated with the one or more managed servers 234 and/or one or more of the data centers 108. The one or more responses 292 may comprise one or more provisioning parameters 138, one or more deployment parameters 160, and/or one or more routing commands 170.

The machine learning operations 206 may comprise one or more operations performed by the server processor 126. The machine learning operations 206 may comprise the one or more models 154. The machine learning operations 206 may comprise one or more operations using one or more supervised models 242, the unsupervised models 244, the one or more neural networks 246, the one or more LLMs 248, the dynamic access commands 250, the evaluation data 252, and the analysis operations 254. The analysis operations 254 may comprise the resources 146 associated to one or more of the data managed servers 234 in the data centers 108, the tracked activity 256, and the predicted activity 258. The supervised models 242 may be one or more models 154 configured to evaluate tracked activity 256 and predicted activity 258 associated with one or more data centers 108 against specific historical data 278. The specific historical data 278 may be information associated with specific data center information 274 associated with a specific managed server 234. The unsupervised models 244 may be one or more models 154 configured to evaluate tracked activity 256 and predicted activity 258 associated with one or more user devices 106 against general historical data 278. The general historical data 278 may be information associated with generalized data center information 274 that is not associated with a specific data center profile 276. The evaluation data 252 may be one or more processed versions of the data elements 290 received from the classical layer operations 202. The evaluation data 252 may be one or more of the configuration feedback 140. The evaluation data 252 may be some of the information used to train the ML algorithms 152, the supervised models 242, and/or the unsupervised models 244.

In some embodiments, the actions and/or operations of the data centers 108 may be evaluated, diagnosed, controlled, and/or managed by the system upon execution of one or more ML algorithms 152 in accordance with one or more models 154. The models 154 may be supervised models 242 and/or unsupervised models 244, among others. The supervised models 242 may be models 154 trained to understand and/or predict operations associated with a specific user profile in the communication network. The unsupervised models 244 may be models 154 trained to understand and/or predict operations associated with general behavior of entities interacting with the communication network. The models 154 may be implemented in accordance with one or more guidelines, to perform network analyses using one or more neural networks 246, and/or one or more LLMs 248. The neural networks 246 may be a computing system comprising a network of interconnected nodes, called artificial neurons, to process data in a decentralized manner. The neural networks 246 may be trained through empirical adverse impact minimization. The neural networks 246 may be configured to optimize operations of a system (e.g., one of the data centers), an apparatus (e.g., one of the servers), and/or additional communication components. Herein, optimization may refer to an iterative approach to evaluate information with the intent of causing one or more performance results that meet one or more dynamic and/or static target performance parameters. The neural networks 246 may be configured to minimize a difference, or empirical adverse impacts, between a predicted output and actual target values in a given dataset. The LLMs 248 may be AI models (e.g., of the models 154) that use machine learning to process and generate human language. The LLMs 248 may be trained on large amounts of data to learn statistical relationships and perform natural language processing (NLP) tasks. The LLMs 248 may be used to generate and translate information, summarize content, determine one or more intents based on the content, recognize content associated with a completion of the intent, and predict additional content to complete the intent. The machine learning operations 206 may be configured to provide one or more triggers 294 to initiate one or more training operations. In turn, the machine learning operations 206 may be configured to receive one or more data elements 296 from the training generation operations 208. The data elements 296 may be configured to indicate one or more training results for consideration and/or analysis at the machine learning operations 206.

The training generation operations 208 may comprise one or more operations performed by the server processor 126. The training generation operations 208 may be one or more training operations configured to generate training data. The system alerts 260 may be one or more error messages, informational messages, and/or reports. The data center data 262 may be one or more data and/or metadata elements configured to form one or more of the configuration feedback 140 and/or the setting configurations 158, among others. The training controls 264 may be one or more instructions configured to guide and/or control usage of training data. The differences 266 may be one or more differentials between a number of available resources 146 and a number of predicted resources 146 to be used in a given data center 108. The reprovisioning windows 268 may be one or more configuration windows in which the server 102 determines to perform one or more updates to the data centers 108 and/or servers in the data centers 108. The target performances 270 may be one or more optimized performances associated with one or more parameters in one or more of the data centers 108. The data center information 274 may be one or more directories associating one or more data centers 108 with one or more entitlements in the system 100. In some embodiments, the entitlements may indicate access commands for the data centers 108 that may be specific to a geographical location 112 and/or a set of operations in the network 110. The data center information 274 may comprise one or more data center profiles configured to catalog one or more aspects of a given data center 108 for reference by the training generation operations 208. The data center profiles 276 may be configured to compile information associated with one or more architectural and/or configuration aspects of a given data center 108. The resources 146 available at a given data center 108 may be considered as one or more elements during one or more of the training generation operations. The historical data 278 may be historic information associated with one or more data centers 108 in a communication network. The historical data 278 may comprise one or more historic indicators representing one or more trend values 282 (e.g., trends) associated with usage of resources 146 in a specific geographical location 112, a specific data center 108, and/or specific services 161.

### Operational Flow to Provision Data Center Resources

In one or more embodiments, the server 102 may be configured to use AI commands 150 and ML algorithms 152 to analyze the historical data 278, the usage patterns 280, and the one or more trend values 282 to predict future server demand, ensuring optimal resource allocation and avoiding over-provisioning or under-provisioning of resources 146 for a given data center 108. There may be many provisioning parameters 138 that go into provisioning of the resources 146. In this regard, the provisioning parameters 138 may be historical, business continuity, resource types, policies, and/or architectural in nature. The server 102 may be configured to use the AI commands 150 and the ML algorithms 152 to analyze the historical data 278, the usage patterns 280, and the one or more trend values 282 to predict future server demand, so that we can optimize provisioning at over provisioning or under provisioning data centers 108 and/or servers in the data centers 108. The server 102 may be configured to consider server capacity, shape, location, latency, and backup protection among other aspects. The server 102 may be configured to generate one or more provisioning plans 134 comprising one or more layouts 136 configured to provide short-term and/or long-term allocation of resources 146 in existing data centers 108 and/or in new/to-be-built data centers 108.

### Operational Flow to Deploy Servers in Data Centers

In one or more embodiments, the server 102 may be configured to use AI commands 150 and ML algorithms 152 to automate provisioning of servers, reducing time and effort required to set up new servers. The server 102 may be configured to automate configuration and/or software installation based on predefined templates or policies. For example, the server 102 may be configured to perform a large percentage (e.g., 60%-90%) of deployment automatically. Further, the server 102 may be configured to automate deployment based on historical data 278 and modeling deployment approaches and/or configurations. The machine-learning-driven deployment may enable one or more specific servers to perform one or more operations in accordance with one or more services 161. The server 102 may be configured to aggregate data from multiple servers and/or data centers 108 that are deployed in a particular tool set and/or server. The data may be shared among multiple servers and/or data centers 108. The aggregated data may be fed into the ML algorithm 152 to make one or more decisions on automated deployment of servers in one or more data centers 108. The aggregation of training data may get a benefit of prior experiences and solutions to known problems as well as some unknown problems, which may lead to an optimized solution.

### Operational Flow to Orchestrate Data Center Resources

In one or more embodiments, the server 102 may be configured to use AI commands 150 and ML algorithms 152 to manage orchestration of various tasks and processes within a data center 108 and/or over multiple data centers 108. The various tasks and processes may comprise load balancing, data backup, and disaster recovery, among others. The server 102 may be configured to determine a number of resources 146 that are historically used at a given geographical location 112a and compare that number to a number of unused resources 146. The server 102 may be configured to determine an availability of resources 146 at the data center 108 based on a difference 266 between a predicted use of resources 146 and a current allowance of unused resources 146. The server 102 may be configured to rebalance traffic loads among one or more data centers 108 based on resource bandwidth availability.

### Example Process to Provision Data Center Resources

FIG. 3 illustrates an example flowchart of a process 300 configured to provision data center resources, in accordance with one or more embodiments. Modifications, additions, or omissions may be made to the process 300. The process 300 may comprise more, fewer, or other operations than those shown in FIG. 3. For example, operations may be performed in parallel or in any suitable order. While at times discussed as the server 102, the data centers 108, or components of any of thereof performing operations described in operations 302-328 in the process 300, any suitable system or components of the system 100 may perform one or more operations of the process 300. For example, one or more operations of the process 300 may be implemented, at least in part, in the form of instructions 132 of FIG. 1, stored on non-transitory, tangible, machine-readable media (e.g., a non-transitory computer-readable medium such as memory 130 of FIG. 1) that when run by one or more processors (e.g., the classical processor 128 of FIG. 1) may cause the one or more processors to perform operations described in operations 302-328.

The process 300 starts at operation 302, where the server 102 is configured to receive first configuration feedback 140 from a first data center 108a. The first configuration feedback 140 may comprise a first usage efficiency 142 of first resources 146 in the first data center 108a. At operation 304, the server 102 is configured to receive second configuration feedback 140 from a second data center 108b. The second configuration feedback 140 may comprise a second usage efficiency 142 of second resources 146 in the second data center 108b. At operation 306, the server 102 is configured execute an artificial intelligence algorithm (e.g., comprising a machine learning algorithm 152) to determine whether the first usage efficiency 142 of the first resources 146 in the first data center 108a is greater than the second usage efficiency 142 of the second resources 146 in the second data center 108b. The artificial intelligence algorithm may be configured, when executed, to evaluate data in accordance with one or more artificial intelligence models 154.

At operation 310, the server 102 is configured to determine whether the first usage efficiency 142 is greater than the second usage efficiency 142. If the server 102 determines that the first usage efficiency 142 is not greater than the second usage efficiency 142 (e.g., NO), the process 300 proceeds to operation 312. At operation 312, the server 102 is configured to determine that the first data center 108a uses the first resources 146 more efficiently than the second data center 108b uses the second resources 146. At operation 314, the server 102 is configured to generate provisioning parameters 138 based at least in part upon the second configuration feedback 140. If the server 102 determines that the first usage efficiency 142 is greater than the second usage efficiency 142 (e.g., YES), the process 300 proceeds to operation 322. At operation 322, the server 102 is configured to determine that the first data center 108a uses the first resources 146 more efficiently than the second data center 108b uses the second resources 146. In response to determining that the first usage efficiency 142 of the first resources 146 in the first data center 108a is greater than the second usage efficiency 142 of the second resources 146 in the second data center 108b, determine that the first data center 108a uses the first resources 146 more efficiently than the second data center 108b uses the second resources 146. At operation 324, the server 102 is configured to generate provisioning parameters 138 based at least in part upon the first configuration feedback 140. The provisioning parameters 138 may comprise guidance to use third resources 146 in a third data center 108c.

The process 300 may end at operation 326 and operation 328, where the server 102 may be configured to generate one or more provisioning plans 134 to provision and deploy the data center 108c. At operation 326, the server 102 is configured to provision a third data center 108c based at least in part upon the provisioning parameters 138. At operation 328, the server 102 is configured to deploy a provisioned version of the third data center 108c based at least in part upon the provisioning parameters 138.

In some embodiments, the server 102 may be configured to generate a provisioning plan 134 to position, over a period of time, the third resources 146 in accordance with a specific layout 136 in the third data center 108c and position the third resources 146 in accordance with the provisioning plan 134 over the period of time. In some embodiments, each of the resources 146 may be associated with specific sub-systems 172-180 in the corresponding data centers 108.

### Example Process to Deploy Servers in Data Centers

FIG. 4 illustrates an example flowchart of a process 400 configured to deploy servers in data centers 108, in accordance with one or more embodiments. Modifications, additions, or omissions may be made to the process 400. The process 400 may comprise more, fewer, or other operations than those shown in FIG. 4. For example, operations may be performed in parallel or in any suitable order. While at times discussed as the server 102, the user devices 106, or components of any of thereof performing operations described in operations 402-436 in the process 400, any suitable system or components of the system 100 may perform one or more operations of the process 400. For example, one or more operations of the process 400 may be implemented, at least in part, in the form of instructions 132 of FIG. 1, stored on non-transitory, tangible, machine-readable media (e.g., a non-transitory computer-readable medium such as memory 130 of FIG. 1) that when run by one or more processors (e.g., the classical processor 128 of FIG. 1) may cause the one or more processors to perform operations described in operations 402-436.

The process 400 starts at operation 402, where the server 102 is configured to receive a first setting configuration 158 associated with a first server of a first data center 108a. The first setting configuration 158 may comprise a first plurality of resources 146 assigned in the first server that are previously determined to meet a first target performance 270 at the first data center 108a. At operation 404, the server 102 is configured to receive a second setting configuration 158 associated with a second server of a second data center 108b. The second setting configuration 158 may comprise a second plurality of resources 146 assigned in the second server that are previously determined to meet a second target performance 270 at the second data center 108b. At operation 406, the server 102 is configured to execute an artificial intelligence algorithm (e.g., comprising a machine learning algorithm 152) to combine the first setting configuration 158 and the second setting configuration 158 into a first combined setting configuration 158. The artificial intelligence algorithm may be configured, when executed, to evaluate data in accordance with one or more models 154. At operation 408, the server 102 is configured to determine multiple parameter categories in the combined setting configuration. At operation 410, the server 102 is configured to generate, based at least in part upon the first combined setting configuration 158, deployment parameters 160 configured to guide provisioning of a third server prior to deployment in a third data center 108c. At operation 412, the server 102 is configured to determine whether third server is in a provisioning window 268.

At operation 420, the server 102 is configured to determine whether the third server is initiated in the provisioning window 268. If the server 102 determines that the third server is not initiated in the provisioning window 268 (e.g., NO), the process 400 proceeds to operation 422. At operation 422, the server 102 is configured to wait until the third server broadcasts that the third server is in the provisioning window 268. If the server 102 determines that the third server is initiated in the provisioning window 268 (e.g., YES), the process 400 proceeds to operation 422. At operation 422, the server 102 is configured to determine that the third server is in a provisioning window 268. At operation 424, the server 102 is configured to provision the third server in accordance with the deployment parameters 160.

The process 400 may end at operation 436, where the server 102 may be configured to deploy a provisioned version of the third server in the third data center 108c.

In some embodiments, the server 102 may be configured to modify operations based on analyses of information associated with several data centers 108. The data centers 108a-108c may be located in different geographical locations 112. The data centers 108a-108c may be located within a same geographical location 112. The resources 146 may be memory resources, processor resources and/or power resources.

### Example Process to Orchestrate Data Center Resources

FIG. 5 illustrates an example flowchart of a process 500 configured to orchestrate data center resources, in accordance with one or more embodiments. Modifications, additions, or omissions may be made to the process 500. The process 500 may comprise more, fewer, or other operations than those shown in FIG. 5. For example, operations may be performed in parallel or in any suitable order. While at times discussed as the server 102, the user devices 106, or components of any of thereof performing operations described in operations 502-536 in the process 500, any suitable system or components of the system 100 may perform one or more operations of the process 500. For example, one or more operations of the process 500 may be implemented, at least in part, in the form of instructions 132 of FIG. 1, stored on non-transitory, tangible, machine-readable media (e.g., a non-transitory computer-readable medium such as memory 130 of FIG. 1) that when run by one or more processors (e.g., the classical processor 128 of FIG. 1) may cause the one or more processors to perform operations described in operations 502-536.

The process 500 starts at operation 502, where the server 102 is configured to receive a first traffic processing availability 144 from a first data center 108a. The first traffic processing availability 144 may comprise first unused resources 146 in the first data center 108a and first predicted resources 146 to be used in the first data center 108a. At operation 504, the server 102 is configured to receive a second traffic processing availability 144 from a second data center 108b. The second traffic processing availability 144 may comprise second unused resources 146 in the second data center and second predicted resources 146 to be used in the second data center 108b. At operation 506, the server 102 is configured to execute a machine learning algorithm 152 to determine whether first unused resources 146 is greater than first predicted resources 146 to be used. The machine learning algorithm 152 may be an artificial intelligence algorithm configured, when executed, to evaluate data in accordance with one or more artificial intelligence models 154.

At operation 510, the server 102 is configured to determine whether the first unused resources 146 is greater than the first predicted resources 146 to be used. If the server 102 determines that the first unused resources 146 is not greater than the first predicted resources 146 to be used (e.g., NO), the process 500 proceeds to operation 512. At operation 512, the server 102 is configured to determine that routing commands 170 cannot be generated at this time. The process 500 may end at operation 512. If the server 102 determines that the first unused resources 146 is greater than the first predicted resources 146 to be used (e.g., YES), the process 500 proceeds to operation 522. At operation 522, the server 102 is configured to determine a first difference 266 of resources 146 between the first unused resources 146 and the first predicted resources 146 to be used. At operation 524, the server 102 is configured to determine whether the second unused resources 146 is less than the second predicted resources 146 to be used.

At operation 520, the server 102 is configured to determine whether the second unused resources 146 is less than the second predicted resources 146 to be used. If the server 102 determines that the second unused resources 146 is not less than the second predicted resources 146 to be used (e.g., NO), the process 500 proceeds to operation 512. At operation 512, the server 102 is configured to determine that routing commands 170 cannot be generated at this time. The process 500 may end at operation 512. If the server 102 determines that the second unused resources 146 is less than the second predicted resources 146 to be used (e.g., YES), the process 500 proceeds to operation 532. At operation 532, the server 102 is configured to generate routing commands 170 configured to distribute a portion of the second difference 266 of resources 146 to the first data center 108a. The portion of the second difference 266 of resources 146 may be less than or equal to the first difference 266 of resources 146. At operation 534, the server 102 is configured to provision the first data center 108a based at least in part upon the routing commands 170.

The process 500 may end at operation 536, where the server 102 may be configured to deploy a provisioned version of the first data center 108a. Herein, the first data center 108a is configured to receive some of the traffic load from the second data center 108b. Thus, the first data center 108a and the second data center 108b may be configured to balance a traffic load between the two data centers 108.

In some embodiments, the first data center 108a and the second data center 108b are located within a same geographical location 112. The first data center 108a and the second data center 108b may be located within different geographical locations 112. The routing commands 170 may be configured to modify allocation of the first unused resources in the first data center. The first unused resources may comprise power resources, memory resources, and/or processor resources.

### Scope of the Disclosure

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system, comprising:
a memory operable to store:
an artificial intelligence algorithm configured to evaluate data in accordance with one or more artificial intelligence models; and
at least one processor communicatively coupled to the memory and configured to:
receive first configuration feedback from a first data center, the first configuration feedback comprising a first usage efficiency of a first plurality of resources in the first data center;
receive second configuration feedback from a second data center, the second configuration feedback comprising a second usage efficiency of a second plurality of resources in the second data center; and
execute the artificial intelligence algorithm to:
determine whether the first usage efficiency of the first plurality of resources in the first data center is greater than the second usage efficiency of the second plurality of resources in the second data center;
in response to determining that the first usage efficiency of the first plurality of resources in the first data center is greater than the second usage efficiency of the second plurality of resources in the second data center, determine that the first data center uses the first plurality of resources more efficiently than the second data center uses the second plurality of resources;
generate a first plurality of provisioning parameters based at least in part upon the first configuration feedback, the first plurality of provisioning parameters comprising guidance to use a third plurality of resources in a third data center;
provision the third data center based at least in part upon the first plurality of provisioning parameters; and
deploy a provisioned version of the third data center based at least in part upon the first plurality of provisioning parameters.

2. The system of claim 1, wherein the at least one processor is further configured to:
in conjunction with generating the first plurality of provisioning parameters based at least in part upon the first configuration feedback, generate a plan to position, over a period of time, the third plurality of resources in accordance with a specific layout in the third data center; and
position the third plurality of resources in accordance with the plan over the period of time.

3. The system of claim 1, wherein the at least one processor is further configured to:
receive third configuration feedback from a fourth data center, the third configuration feedback comprising a third usage efficiency of a fourth plurality of resources in the fourth data center;
receive fourth configuration feedback from a fifth data center, the fourth configuration feedback comprising a fourth usage efficiency of a fifth plurality of resources in the fifth data center; and
execute the artificial intelligence algorithm to:
determine whether the third usage efficiency of the third plurality of resources in the fourth data center is less than the fourth usage efficiency of the fourth plurality of resources in the fifth data center;
in response to determining that the third usage efficiency of the fourth plurality of resources in the fourth data center is less than the fourth usage efficiency of the fifth plurality of resources in the fifth data center, determine that the fourth data center uses the fourth plurality of resources less efficiently than the fifth data center uses the fifth plurality of resources;
generate a second plurality of provisioning parameters based at least in part upon the fourth configuration feedback, the second plurality of provisioning parameters comprising guidance to use the third plurality of resources in the third data center;
reprovision the third data center based at least in part upon the second plurality of provisioning parameters; and
deploy a reprovisioned version of the third data center based at least in part upon the second plurality of provisioning parameters.

4. The system of claim 1, wherein the at least one processor is further configured to:
receive third configuration feedback from a fourth data center, the third configuration feedback comprising a third usage efficiency of a fourth plurality of resources in the fourth data center;
receive fourth configuration feedback from a fifth data center, the fourth configuration feedback comprising a fourth usage efficiency of a fifth plurality of resources in the fifth data center; and
execute the artificial intelligence algorithm to:
determine whether the third usage efficiency of the third plurality of resources in the fourth data center is greater than the fourth usage efficiency of the fourth plurality of resources in the fifth data center;
in response to determining that the third usage efficiency of the fourth plurality of resources in the fourth data center is greater than the fourth usage efficiency of the fifth plurality of resources in the fifth data center, determine that the fourth data center uses the fourth plurality of resources more efficiently than the fifth data center uses the fifth plurality of resources;
generate a second plurality of provisioning parameters based at least in part upon the third configuration feedback, the second plurality of provisioning parameters comprising guidance to use a sixth plurality of resources in a sixth data center;
provision the sixth data center based at least in part upon the second plurality of provisioning parameters; and
deploy a provisioned version of the sixth data center based at least in part upon the second plurality of provisioning parameters.

5. The system of claim 1, wherein:
the first plurality of resources is used in a first sub-system in the first data center;
the second plurality of resources is used in a second sub-system in the second data center; and
the third plurality of resources is used in a third sub-system in the third data center.

6. The system of claim 5, wherein:
the first sub-system, the second sub-system, and the third sub-system are associated with one or more heating, ventilation, and air conditioning (HVAC) operations in the first data center, the second data center, and the third data center, respectively.

7. The system of claim 5, wherein:
the first sub-system, the second sub-system, and the third sub-system are associated with one or more power supply operations in the first data center, the second data center, and the third data center, respectively.

8. The system of claim 5, wherein:
the first sub-system, the second sub-system, and the third sub-system are associated with one or more automation operations in the first data center, the second data center, and the third data center, respectively.

9. The system of claim 5, wherein:
the first sub-system, the second sub-system, and the third sub-system are associated with one or more security operations in the first data center, the second data center, and the third data center, respectively.

10. The system of claim 5, wherein:
the first sub-system, the second sub-system, and the third sub-system are associated with one or more server farm operations in the first data center, the second data center, and the third data center, respectively.

11. A method, comprising:
receiving first configuration feedback from a first data center, the first configuration feedback comprising a first usage efficiency of a first plurality of resources in the first data center;
receiving second configuration feedback from a second data center, the second configuration feedback comprising a second usage efficiency of a second plurality of resources in the second data center; and
execute an artificial intelligence algorithm to perform one or more operations comprising:
determining whether the first usage efficiency of the first plurality of resources in the first data center is greater than the second usage efficiency of the second plurality of resources in the second data center;
in response to determining that the first usage efficiency of the first plurality of resources in the first data center is greater than the second usage efficiency of the second plurality of resources in the second data center, determining that the first data center uses the first plurality of resources more efficiently than the second data center uses the second plurality of resources;
generating a first plurality of provisioning parameters based at least in part upon the first configuration feedback, the first plurality of provisioning parameters comprising guidance to use a third plurality of resources in a third data center;
provisioning the third data center based at least in part upon the first plurality of provisioning parameters; and
deploying a provisioned version of the third data center based at least in part upon the first plurality of provisioning parameters.

12. The method of claim 11, further comprising:
in conjunction with generating the first plurality of provisioning parameters based at least in part upon the first configuration feedback, generating a plan to position, over a period of time, the third plurality of resources in accordance with a specific layout in the third data center; and
positioning the third plurality of resources in accordance with the plan over the period of time.

13. The method of claim 11, further comprising:
receiving third configuration feedback from a fourth data center, the third configuration feedback comprising a third usage efficiency of a fourth plurality of resources in the fourth data center;
receiving fourth configuration feedback from a fifth data center, the fourth configuration feedback comprising a fourth usage efficiency of a fifth plurality of resources in the fifth data center; and
executing the artificial intelligence algorithm to perform one or more additional operations comprising:
determining whether the third usage efficiency of the third plurality of resources in the fourth data center is less than the fourth usage efficiency of the fourth plurality of resources in the fifth data center;
in response to determining that the third usage efficiency of the fourth plurality of resources in the fourth data center is less than the fourth usage efficiency of the fifth plurality of resources in the fifth data center, determining that the fourth data center uses the fourth plurality of resources less efficiently than the fifth data center uses the fifth plurality of resources;
generating a second plurality of provisioning parameters based at least in part upon the fourth configuration feedback, the second plurality of provisioning parameters comprising guidance to use the third plurality of resources in the third data center;
reprovisioning the third data center based at least in part upon the second plurality of provisioning parameters; and
deploying a reprovisioned version of the third data center based at least in part upon the second plurality of provisioning parameters.

14. The method of claim 11, further comprising:
receiving third configuration feedback from a fourth data center, the third configuration feedback comprising a third usage efficiency of a fourth plurality of resources in the fourth data center;
receiving fourth configuration feedback from a fifth data center, the fourth configuration feedback comprising a fourth usage efficiency of a fifth plurality of resources in the fifth data center; and
executing the artificial intelligence algorithm to perform one or more additional operations comprising:
determining whether the third usage efficiency of the third plurality of resources in the fourth data center is greater than the fourth usage efficiency of the fourth plurality of resources in the fifth data center;
in response to determining that the third usage efficiency of the fourth plurality of resources in the fourth data center is greater than the fourth usage efficiency of the fifth plurality of resources in the fifth data center, determining that the fourth data center uses the fourth plurality of resources more efficiently than the fifth data center uses the fifth plurality of resources;
generating a second plurality of provisioning parameters based at least in part upon the third configuration feedback, the second plurality of provisioning parameters comprising guidance to use a sixth plurality of resources in a sixth data center;
provisioning the sixth data center based at least in part upon the second plurality of provisioning parameters; and
deploying a provisioned version of the sixth data center based at least in part upon the second plurality of provisioning parameters.

15. The method of claim 11, wherein:
the first plurality of resources is used in a first sub-system in the first data center;
the second plurality of resources is used in a second sub-system in the second data center; and
the third plurality of resources is used in a third sub-system in the third data center.

16. A non-transitory computer-readable medium storing instructions that when executed by a processor cause the processor to:
receive first configuration feedback from a first data center, the first configuration feedback comprising a first usage efficiency of a first plurality of resources in the first data center;
receive second configuration feedback from a second data center, the second configuration feedback comprising a second usage efficiency of a second plurality of resources in the second data center; and
execute an artificial intelligence algorithm to:
determine whether the first usage efficiency of the first plurality of resources in the first data center is greater than the second usage efficiency of the second plurality of resources in the second data center;
in response to determining that the first usage efficiency of the first plurality of resources in the first data center is greater than the second usage efficiency of the second plurality of resources in the second data center, determine that the first data center uses the first plurality of resources more efficiently than the second data center uses the second plurality of resources;
generate a first plurality of provisioning parameters based at least in part upon the first configuration feedback, the first plurality of provisioning parameters comprising guidance to use a third plurality of resources in a third data center;
provision the third data center based at least in part upon the first plurality of provisioning parameters; and
deploy a provisioned version of the third data center based at least in part upon the first plurality of provisioning parameters.

17. The non-transitory computer-readable medium of claim 16, wherein, when executed by the processor, the instructions further cause the processor to:
in conjunction with generating the first plurality of provisioning parameters based at least in part upon the first configuration feedback, generate a plan to position, over a period of time, the third plurality of resources in accordance with a specific layout in the third data center; and
position the third plurality of resources in accordance with the plan over the period of time.

18. The non-transitory computer-readable medium of claim 16, wherein, when executed by the processor, the instructions further cause the processor to:
receive third configuration feedback from a fourth data center, the third configuration feedback comprising a third usage efficiency of a fourth plurality of resources in the fourth data center;
receive fourth configuration feedback from a fifth data center, the fourth configuration feedback comprising a fourth usage efficiency of a fifth plurality of resources in the fifth data center; and
execute the artificial intelligence algorithm to:
determine whether the third usage efficiency of the third plurality of resources in the fourth data center is less than the fourth usage efficiency of the fourth plurality of resources in the fifth data center;
in response to determining that the third usage efficiency of the fourth plurality of resources in the fourth data center is less than the fourth usage efficiency of the fifth plurality of resources in the fifth data center, determine that the fourth data center uses the fourth plurality of resources less efficiently than the fifth data center uses the fifth plurality of resources;
generate a second plurality of provisioning parameters based at least in part upon the fourth configuration feedback, the second plurality of provisioning parameters comprising guidance to use the third plurality of resources in the third data center;
reprovision the third data center based at least in part upon the second plurality of provisioning parameters; and
deploy a reprovisioned version of the third data center based at least in part upon the second plurality of provisioning parameters.

19. The non-transitory computer-readable medium of claim 16, wherein, when executed by the processor, the instructions further cause the processor to:
receive third configuration feedback from a fourth data center, the third configuration feedback comprising a third usage efficiency of a fourth plurality of resources in the fourth data center;
receive fourth configuration feedback from a fifth data center, the fourth configuration feedback comprising a fourth usage efficiency of a fifth plurality of resources in the fifth data center; and
execute the artificial intelligence algorithm to:
determine whether the third usage efficiency of the third plurality of resources in the fourth data center is greater than the fourth usage efficiency of the fourth plurality of resources in the fifth data center;
in response to determining that the third usage efficiency of the fourth plurality of resources in the fourth data center is greater than the fourth usage efficiency of the fifth plurality of resources in the fifth data center, determine that the fourth data center uses the fourth plurality of resources more efficiently than the fifth data center uses the fifth plurality of resources;
generate a second plurality of provisioning parameters based at least in part upon the third configuration feedback, the second plurality of provisioning parameters comprising guidance to use a sixth plurality of resources in a sixth data center;
provision the sixth data center based at least in part upon the second plurality of provisioning parameters; and
deploy a provisioned version of the sixth data center based at least in part upon the second plurality of provisioning parameters.

20. The non-transitory computer-readable medium of claim 16, wherein:
the first plurality of resources is used in a first sub-system in the first data center;
the second plurality of resources is used in a second sub-system in the second data center; and
the third plurality of resources is used in a third sub-system in the third data center.
